(19) United States
(12) Patent Application Publication
(10) Pub. No.: US 2024/0082887 A1
(43) Pub. Date: Mar. 14, 2024

(54) ULTRASONIC SELF-CLEANING AIR FILTRATION DEVICE

(71) Applicants: Manuel CORREIA, YERRES (FR); AILAU PROTECT, Villeneuve-Saint-Georges (FR)

(72) Inventor: Manuel CORREIA, Yerres (FR)

(21) Appl. No.: 18/262,112

(22) PCT Filed: Jan. 21, 2022
(86) PCT No.: PCT/FR2022/000005

§ 371 Date: Jul. 19, 2023

(30) Foreign Application Priority Data
Jan. 23, 2021 (FR) FR2100640

(51) Int. Cl. B08B 3/12; B01D 47/02

(52) U.S. Cl. CPC B08B 3/12; B01D 47/02

(57) ABSTRACT

The present invention relates to an ultrasonic self-cleaning air filtration system, comprising at least one tank (1), a ventilation system (5), at least one water inlet (3), at least one water outlet (4), at least one shutter (18), at least one ultrasonic generator (2) and a computer program allowing the self-cleaning of the system. The invention also relates to a method for the automated cleaning of said air filtration system. This method is intended in particular to make the use of existing filtration systems more efficient and economical.

### FIELD OF THE INVENTION

The present invention relates to an ultrasonic self-cleaning air filtration system, comprising at least one tank (1), a ventilation system (5), at least one water inlet (3), at least one water outlet (4), at least one shutter (18), at least one ultrasonic generator (2) and a computer program allowing the self-cleaning of the system. The invention also relates to a method for the automated cleaning of said air filtration system. This method is intended in particular to make the use of existing filtration systems more efficient and economical.

### DESCRIPTION OF THE PRIOR ART

Climate change and its long-term effects on the planet require our nations and governments to reduce, sometimes drastically, our carbon footprint. Thus, certain everyday devices are destined to change and/or disappear. This is for example the case of gas and/or oil-fired boilers. The latter are gradually being replaced by heat pump, thermodynamic balloon and/or double-flow CMV solutions. Due to their design, these systems still often remain too energy-intensive in terms of electrical consumption.

Thermodynamic balloons and/or double-flow CMV use different filtration systems, yet these filtration systems have numerous weaknesses and drawbacks. Firstly, their filters foul very quickly. These various drawbacks therefore engage various corrective actions, such as regular changing of oil and/or dust filters and other corrective actions on their rotating elements.

Examples of air filtration that are more suitable in the prior art are patents ES1258715U and CN300249342. They illustrate more sophisticated air filtration means, since they use the water filtration system, in different forms and aspects, that has been known for many years, in particular in domestic vacuum cleaners. However, these various means used require timely regular and rigorous maintenance to clean and maintain their grease and/or dust filters and for other corrective actions on their rotating elements contained in their dirty water tanks. The efficiency of such systems is also dependent on the regular addition of detergent products. The present invention relates to a self-cleaning air filtration system intended to make the use of current ventilation systems more efficient and more economical.

The present invention aims to compensate for the various technical and structural absences of the cited solutions by providing essential aspects and means in terms of materials, methods and embodiments.

Thus, a first subject matter of the present invention relates to a self-cleaning air filtration system comprising:
At least one tank (1) comprising water in liquid form and allowing the passage of air;
An electromechanical and/or mechanical ventilation system (5);
At least one water inlet (3) and at least one water outlet (4) in said at least one tank (1);
At least one shutter (18) allowing the tank (1) to be made hermetic when said ventilation system (5) is stopped;
At least one ultrasonic generator (2), integrated into said at least one tank (1), said at least one ultrasonic generator (2) being able to generate ultrasounds on all the elements of the air filtration system contained and immersed in said tank (1); and
A computer program suitable for,
Controlling the start-up and stopping of said electromechanical and/or mechanical ventilation system (5);
Controlling said at least one water inlet (3) for filling said at least one tank (1);
Controlling said at least one ultrasonic generator (2) to generate an ultrasonic flow in the water of said at least one tank (1);
Controlling said at least one outlet (4) for emptying said at least one tank (1).

According to the invention, the term “air filtration system” is understood to mean an air filtration system which sanitizes the air that it stirs, during the passage of the air in contact with water in liquid form. The invention, due to its technology, is adaptable and suitable for integration with all types of structures.

Within the meaning of the invention, “adaptable and suitable for integration with all types of structures” means that said self-cleaning air filtration system can be implemented in any type of structure allowing air to circulate in a construction, for example in a building or hospital.

Within the meaning of the invention, “self-cleaning” is understood to mean a system that cleans itself autonomously, without outside human intervention, during a preprogrammed maintenance phase, when said elements present in said at least one tank (1) are clogged by the air stirred in the system.

“Water in liquid form” is understood to mean that the water contained in the tank (1) is in liquid form. During the conventional air filtration phase, only a small part of the elements of the filtration system contained in the tank (1) are immersed by this water.

Within the meaning of the present invention, the expression “the elements contained in said at least one tank (1)” is understood to mean all the elements included in the air filtration system, such as in particular said electromechanical and/or mechanical ventilation system (5), said at least one water inlet (3), said at least one water outlet (4), said at least one shutter (18) allowing the tank to be made hermetic, said at least one ultrasonic generator (2).

According to the invention, the term “electromechanical and/or mechanical ventilation system (5)” is understood to mean a system capable of stirring the air that passes into the air filtration system. This system may be mechanical or electromechanical, in the sense that said ventilation system (5) may be electronically controlled according to the requirements and the resources provided. The mechanical and/or electromechanical ventilation system (5) is designed to adapt its speed based on the need for stirring air in the building and/or in the room where it is installed.

Within the meaning of the present invention, the term “at least one water inlet (3)” is understood to mean a means for supplying water in the tank (1). Preferably, said water inlet (3) comprises at least one water inlet valve (3) and is connected to the tap water network.

Within the meaning of the present invention, the term “at least one water outlet (4)” is understood to mean a means all or at least a part of the water contained in the tank to be removed. Preferably, said at least one water outlet (4) comprises at least one discharge valve for the dirty water (4) from the cleaning and is connected to a waste water pipe.

Within the meaning of the present invention, the term “at least one shutter (18)” is understood to mean an element allowing said at least one tank (1) to be closed during stopping of the ventilation in order to guarantee complete sealing of said tank.

According to one embodiment, said at least one shutter (18) comprises a spring clip that is raised when the ventilation is on, and that is folded down when the ventilation is stopped.

According to one embodiment, said at least one shutter (18) comprises a rubber valve, of the sanitary sealing mechanism type.

According to one embodiment, said at least one shutter (18) comprises a float that, when the tank (1) is filled with water during the self-cleaning phase, stops and/or obstructs said at least one water inlet (3) or other elements of the system.

According to the invention, the term “at least one ultrasonic generator (2)” is understood to mean a device acting on the water soiled by the air filtered by said system, and allowing the self-cleaning of said system by generating ultrasounds with a frequency of between 20 KHz to 40 KHz, preferably between 25 KHz and 40 KHz, for the purpose of cleaning the elements contained in said at least one tank (1) of the air filtration system. Said at least one generator generates very high-frequency electrical energy, this energy being transformed into vibrations, thus allowing the dirt to be detached from the various elements of the air filtration system, contained in said at least one tank (1), by deep-cleaning them and by degreasing them. Said at least one ultrasonic generator (2) also even allows the wall of said at least one tank (1) to be unclogged, thus allowing the efficiency of the various water renewal and filtration cycles to be ensured, by completely cleaning the various elements of the air filtration system that are present in said at least one tank (1) and that are soiled by the air stirred in said system. Furthermore, said at least one ultrasonic generator (2) allows the various aforementioned elements to be deoxidized and brightened.

“Submerged” is understood to mean that the elements included in said at least one tank (1) are completely covered with water.

According to the invention, the term “at least one tank (1)” or “chamber” is understood to mean at least one element allowing all of the parts of the air filtration system according to the invention to be contained, allowing the passage of the air to be filtered during the operation of the filtration system, and during self-cleaning allowing the water to be contained that will allow the cleaning of the parts contained by the ultrasonic generator.

According to the invention, “a computer program suitable for” means a computer program for implementing the method for automated cleaning of the air filtration system according to the invention.

According to the invention, “preprogrammed maintenance phase” is understood to mean programming upstream of a maintenance phase of the air filtration system. The programming of the preprogrammed self-cleaning cycle may be daily, weekly or even monthly or annual, depending on the use of the air filtration system. The periodicity is to be adapted, depending on the structural and environmental characteristics of the where the equipment is housed and depending on the needs and the use of said air filtration system.

Within the meaning of the invention, the term “adjusting the temperature of the water” is understood to mean that the computer program is capable of sending instructions by means of heating the water so that the latter is at a precise temperature when it arrives in the tank by said at least one water inlet (3). Preferably, the water is heated to a temperature between 40° C. and 75° C., to allow detaching of dirt present on the ventilation elements (5) that are present in said at least one tank (1), and on the walls of said at least one tank (1).

Preferably according to the invention, said at least one computer program may, during a preprogrammed maintenance phase, control the temperature of the water contained in the heat pump (6) at a temperature between 40° C. and 75° C., preferably between 60° C. and 75° C., preferably 65° C. The temperature control makes it possible, in a first step, to facilitate the cleaning of said elements contained in said at least one tank (1) such as the ventilation elements (5), for example, in the sense that the cleaning time is shortened proportionally to the selected temperature increase. The higher the temperature, the faster the cleaning of said aforementioned elements will be. Secondly, the control of the temperature is also part of a sanitary issue, in the sense that the increase in temperature makes allows avoidance of the proliferation of legionella bacteria in said heat pump (6). Indeed, legionella bacteria are naturally present in water and in sludge and are responsible for legionellosis. These bacteria grow and proliferate in stagnant water. A temperature above 60° C. makes it possible to stop them from multiplying and to destroy them.

“Controlling the start-up and stopping of said electromechanical and/or mechanical ventilation system (5)” is understood to mean that the computer program can act on this element to actuate or stop it, as well as to modify the speed of rotation of the ventilation system.

Even more preferably, the speed of rotation of the elements of said electromechanical and/or mechanical ventilation system (5) has a speed of between 1,100 and 3,900 rpm, preferably between 1,320 and 2,850 rpm.

Preferably according to the invention, said ultrasonic generator (2) allows generation of an ultrasonic flow at a frequency of between 20 KHz and 40 KHz, preferably between 25 KHz and 40 KHz.

Preferably according to the invention, said self-cleaning air filtration system comprises a microcontroller (10).

Within the meaning of the present invention, “microcontroller (10)” is understood to mean an integrated and compact circuit designed to govern a specific operation in an integrated system. It comprises a processor, a memory (11) and input and output peripherals on at least one card. Said microcontroller (10) is an autonomous component, capable of executing the computer program contained in its memory as soon as it is powered up. Said microcontroller is integrated into said air filtration system in order to allow it to carry out the filtration and/or self-cleaning steps, and/or the on/off-type remote actions and/or an action of the smoothing type with respect to the electrical consumption during its various usage phases, in order to respond to the various peaks of excess consumption and/or under-production of energy linked to the transport infrastructures of energy networks. The equipment will thus be able to respond to the environmental challenges represented by energy production and storage.

Preferably according to the invention, said self-cleaning air filtration system comprises a memory (11).

Within the meaning of the present invention, the term “memory” refers to a physical device allowing information or data to be maintained and retrieved.

Preferably according to the invention, said self-cleaning air filtration system comprises at least one sensor.

Within the meaning of the present invention, the term “sensor” is understood to mean a physical device allowing sampling of information or data

Preferably, the self-cleaning air filtration system according to the invention comprises a microcontroller (10) and/or a memory (11) and/or at least one sensor.

Preferably, the self-cleaning air filtration system according to the invention incorporates an Ethernet connection (12) and/or a radio transceiver (13) of WIFI, LPWAN and/or 4G LTE and/or 5G type. These elements allow the system according to the invention to communicate, and allow instructions to be executed to be sent thereto.

Preferably, the self-cleaning air filtration system according to the invention comprises a control unit (9) that integrates a power supply and an electronic control circuit.

According to the present invention, the term “control unit (9)” is understood to mean a control member (9) allowing management of the various operating parameters of the system according to the invention. Said control unit (9) is integrated into said frame (14).

Within the meaning of the invention, “operating parameter” is understood to mean the parameters selectable during the preprogramming of the maintenance phase of said air filtration system. Said parameters comprise:
Selecting the temperature of the water that will allow filling of said at least one tank (1) of said air filtration system and detachment of dirt from the elements contained in said at least one tank (1);
Stopping, starting and/or adjusting the speed of rotation of the elements of said electromechanical and/or mechanical ventilation system;
Selecting the number of self-cleaning cycles of the air filtration system, based on the use of said system;
Selecting the frequency of ultrasound to be generated by said at least one ultrasonic generator (2).

Preferably according to the invention, said electromechanical and/or mechanical ventilation system (5) comprises a motor drive of the winding rotor and/or permanent rotor and/or brushless rotor type.

Said permanent and/or brushless rotor does not heat and is more energy efficient.

According to one embodiment, this motor drive consumes very little energy and does not emit heat. This motor drive is placed either outside and/or inside said at least one tank (1); when the motor drive is inside said at least one tank (1), it is made leak-tight.

In another embodiment, when the fan is attached to the outside on one of the sides of said tank, the system ensures closing of the orifice of the passage of the axis of the ventilation unit motor by integrating a motor of the geared motor type.

The latter is placed outside the tank and is aligned with the axis of the ventilation unit motor. Said geared motor will produce traction on said axis of the ventilation unit rotor so as to cause the SPI seal that is attached to said rotor of the ventilation unit, which is situated inside said at least one tank (1) between the turbine and the wall of said at least one tank (1), to close off the space left empty, between the axis of the ventilation unit rotor and said at least one tank (1) to ensure perfect sealing of said at least one tank (1) during the self-cleaning cycle of said air filtration system.

Preferably according to the invention, said at least one water inlet (3) and said at least one water outlet (4) are connected to valves. More preferably, said valves can be automatically actuated by said computer program.

Even more preferably, said at least one water inlet (3) is connected to the tap water network.

Even more preferably, said at least one outlet (4) is connected to a waste water pipe.

Preferably, the self-cleaning air filtration system according to the invention comprises at least one means for heating the water arriving by said at least one water inlet (3).

Within the meaning of the invention, the term “means for heating the water” is understood to mean a system allowing the temperature of the water that it contains to be influenced in order to obtain water at a precise temperature. Preferably according to the invention, said computer program allows control of the temperature of the water of said means for heating the water arriving by said at least one water inlet (3). Even more preferably, said computer program can adjust the temperature of the water between 40° C. and 75° C., preferably between 60° C. and 75° C., more preferably at 65° C.

Preferably according to the invention, said means for heating the water comprises means for recovering calories discharged by the air filtration system, situated in said at least one tank (1), preferably said means for recovering said calories being an exchanger (7).

Within the meaning of the invention, “recovering calories” is understood to mean storing said calories and returning them to said system based on the needs thereof.

Even more preferably, said means for heating the water is chosen from a reversible heat pump (6), a boiler, a double-flow CMV, or a balloon, preferably thermodynamic.

These means for heating the water make it possible to transfer energy from a cold source to a hot source and/or vice versa.

Preferably, said means for heating the water is a reversible heat pump (6). Said heat pump (6) allows heating of the water that will be dispensed by said at least one water inlet (3) in said at least one tank (1), by means of its compressor, at a speed previously selected during the preprogramming of the maintenance phase of said air filtration system. Said heat pump (6) may be of the hybrid type, in the sense that said heat pump (6) is combined with a pellet stove and operates via a method called cold plasma for the removal of mineral and organic pollutants that will be generated by combustion and by the various ventilation units of this system.

Preferably according to the invention, said self-cleaning air filtration system incorporates a heating resistor (8) in said at least one tank (1) containing the water in order to accelerate, if necessary, the cleaning effect of said at least one ultrasonic generator (2), for the same reasons that the use of hotter water allows faster cleaning.

This heating resistor (8), if necessary, provides a supply of calories, which are then transmitted to the water in contact with the exchanger (7) of the heat pump (6).

In this embodiment, said calories are stored in a system for recovering calories, attached to the thermodynamic balloon; the recovery system is of the oil bath and/or phase change type, as is paraffin, to store said calories and restore them to the system depending on the need for hot water during the self-cleaning cycle of the air filtration system. This supply of calories combined with the operation of said at least one ultrasonic generator (2) allows an increased efficiency of the self-cleaning cycle of the air filtration system.

Preferably according to the invention, said self-cleaning air filtration system incorporates at least one cold plasma generator in said at least one tank (1).

Within the meaning of the present invention, “cold plasma generator” or “bipolar ionization” is understood to mean this decontamination technique without chemical products, consisting of an ionizing bipolar ion generator placed in said at least one tank (1) to amplify the reduction of particles in suspension, the destruction of bacteria, and the reduction of volatile organic compounds and all other particles of flue gas present in the stirred air and sanitized by said air filtration system. The cold plasma generator allows the release of positive and negative ions, which will propagate in the ambient air to neutralize pathogens, including viruses.

A second object of the invention relates to an assembly comprising a self-cleaning air filtration system and a frame (14), where the various elements of said system are protected from outside factors and influences by said frame (14).

“Frame” is understood to mean a device made of resistant material, allowing said system according to the invention to be surrounded.

According to the invention, “outside factors and influences” means unwanted human or animal interactions with said air filtration system, natural disasters such as floods, etc.

A third object of the invention relates to a method for automated cleaning of an air filtration system according to the invention, implemented by said at least one computer program, said method comprising the following steps:
i. a step of stopping said electromechanical and/or mechanical ventilation system (5), causing said at least one shutter (18) to be closed, allowing sealing of the tank (1);
ii. a step of filling said at least one tank (1) comprising the various elements of the air filtration system with water through the opening of said at least one water inlet (3), which is then closed;
iii. a step of generating ultrasounds in the water of said at least one tank (1), allowing cleaning of said elements of the air filtration system;
iv. a step of discharging the water from said at least one tank (1) owing to the opening of said at least one water outlet (4);
v. obtaining a cleaned air filtration system.

Preferably, said computer program is preprogrammed so that said air filtration system is cleaned regularly, preferably daily, weekly, monthly or annually, based on the needs and uses of said air filtration system.

Following steps i. to v., the air filtration system resumes its conventional air filtration operation, until the next self-cleaning sequence.

Within the meaning of the invention, “regular cleaning” is understood to mean that it allows the selection of the number of self-cleaning cycles of the air filtration system, based on the use of said system. This frequency of the self-cleaning cycle is determined based on the structural and environmental characteristics of where the equipment is housed. The periodicity of said self-cleaning cycle of said system is adapted based on requirements and may therefore be preprogrammed daily, weekly, monthly or else annually if said air filtration system does not require regular cleaning with respect to low use of said air filtration system or if, on the contrary, the use of said system requires regular cleaning of said air filtration system.

### DRAWINGS

FIG. 1 is a side overview embodying on the one hand the frame (14) on the left side of the figure, comprising the self-cleaning air filtration system according to the invention, and on the other hand a means of heating the water, in this case a heat pump (6) on the right side of said figure.

FIG. 2 is a top view showing said ultrasonic self-cleaning air filtration system, comprising the following elements:
The tank (1);
The ultrasonic generator (2);
The water inlet (3);
The waste water outlet (4);
The ventilation system (5);
The exchanger (7);
The heating resistor (8); and
The control unit (9).

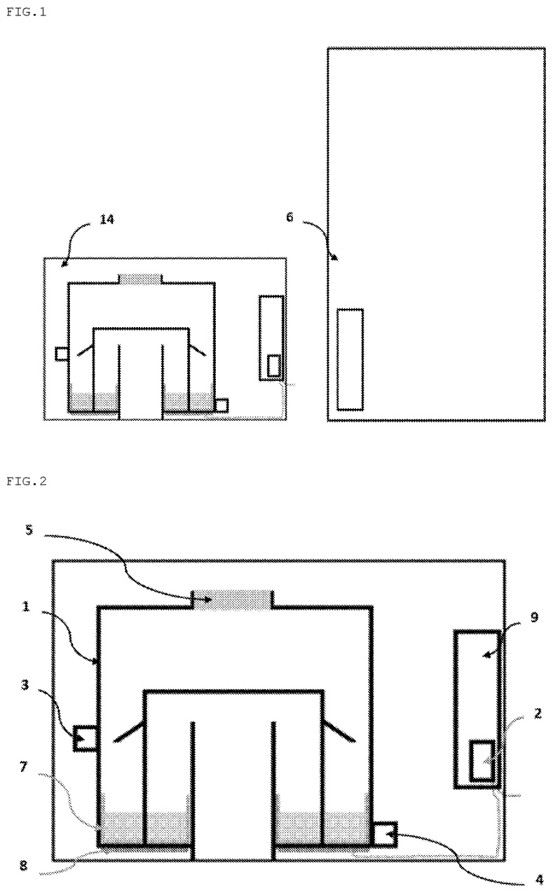

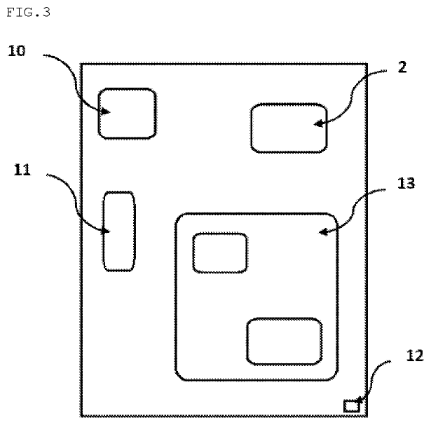

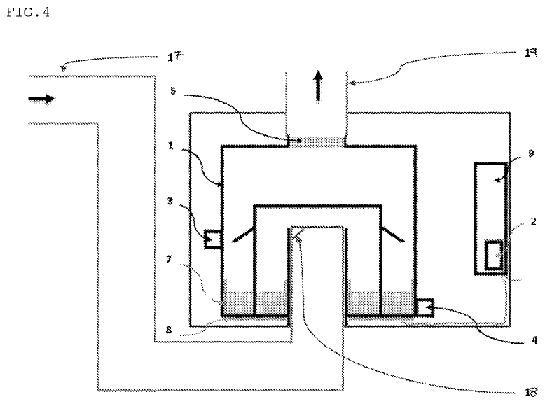

Said aforementioned elements are contained in the aforementioned frame (14) in FIG. 1.

FIG. 3 is a side view showing the control unit (9) of the computer program, comprising the following elements:
A microcontroller (10);
A memory (11);
An Ethernet connection (12); and
A radio transceiver (13).

This figure further comprises an illustration of the ultrasonic generator (2).

FIG. 4 is a side view generally showing the self-cleaning air filtration system and the cooperation of its various component elements. This figure shows the various ducts constituting the external connections toward the building and/or the room to be ventilated. The following elements are visible in addition to the joint elements in FIG. 2:
An air inlet duct (17);
A leak-tight shutter (18) attached to the air inlet duct; and
An air outlet duct (19).

1. A self-cleaning air filtration system comprising:
At least one tank comprising water in liquid form and allowing the passage of air;
An electromechanical and/or mechanical ventilation system;
At least one water inlet and at least one water outlet in said at least one tank;
At least one shutter allowing the tank to be made hermetic when said ventilation system is stopped;
At least one ultrasonic generator, integrated into said at least one tank, said at least one ultrasonic generator being able to generate ultrasounds on all the elements of the air filtration system contained and immersed in said tank; and
A computer program suitable for:
Controlling the start-up and stopping of said electromechanical and/or mechanical ventilation system;
Controlling said at least one water inlet for filling said at least one tank;
Controlling said at least one ultrasonic generator to generate an ultrasonic flow in the water of said at least one tank;
Controlling said at least one outlet for emptying said at least one tank.

2. The self-cleaning air filtration system according to claim 1, characterized in that said ultrasonic generator allows generation of an ultrasonic flow at a frequency of between 20 KHz and 40 KHz, preferably between 25 KHz and 40 KHz.

3. The self-cleaning air filtration system according to claim 1, characterized in that it comprises a microcontroller and/or a memory and/or at least one sensor.

4. The self-cleaning air filtration system according to claim 1, characterized in that it incorporates an Ethernet connection and/or a radio transceiver of WIFI, LPWAN and/or 4G LTE and/or 5G type.

5. The self-cleaning air filtration system according to claim 1, characterized in that it comprises a control unit that incorporates a power supply and an electronic control circuit.

6. The self-cleaning air filtration system according to claim 1, characterized in that said at least one electromechanical and/or mechanical ventilation system comprises a motor drive of the winding rotor and/or permanent rotor and/or brushless rotor type.

7. The self-cleaning air filtration system according to claim 1, characterized in that said at least one water inlet and said at least one water outlet are connected to valves that can be automatically actuated by said computer program.

8. The self-cleaning air filtration system according to claim 1, characterized in that it comprises at least one means for heating the water arriving by said at least one water inlet.

9. The self-cleaning air filtration system according to claim 8, characterized in that said computer program allows control of the temperature of the water of said means for heating the water arriving by said at least one water inlet.

10. The self-cleaning air filtration system according to claim 9, characterized in that said computer program can adjust the temperature of the water between 40° C. and 75° C., preferably between 60° C. and 75° C., more preferably at 65° C.

11. The self-cleaning air filtration system according to claim 8, characterized in that said means for heating the water comprises means for recovering calories discharged by the air filtration system, situated in said at least one tank, preferably said means for recovering said calories being an exchanger.

12. The self-cleaning air filtration system according to claim 8, characterized in that said means for heating the water is chosen from a reversible heat pump, a boiler, a double-flow CMV or a balloon, preferably thermodynamic.

13. An assembly comprising a self-cleaning air filtration system according to claim 1 and a frame, characterized in that the various elements of said system are protected from outside factors and influences by said frame.

14. A method for automated cleaning of an air filtration system according to claim 1, implemented by said computer program, characterized in that it comprises:
i. a step of stopping said electromechanical and/or mechanical ventilation system, causing said at least one shutter to be closed, allowing sealing of the tank;
ii. a step of filling said at least one tank comprising the various elements of the air filtration system with water through the opening of said at least one water inlet, which is then closed;
iii. a step of generating ultrasounds in the water of said at least one tank, allowing cleaning of said elements of the air filtration system;
iv. a step of discharging the water from said at least one tank owing to the opening of said at least one water outlet;
v. obtaining a cleaned air filtration system.

15. The method for automated cleaning of an air filtration system according to claim 14, characterized in that said computer program is preprogrammed so that said air filtration system is cleaned regularly, preferably daily, weekly, monthly or annually, based on the needs and uses of said air filtration system.
